(19) United States
(12) Patent Application Publication
(10) Pub. No.: US 2014/0283339 A1
(43) Pub. Date: Sep. 25, 2014

(54) LOCKING CLIP

(71) Applicant: BAE SYSTEMS PLC, London (GB)

(72) Inventors: Sean Gallagher, Lancashire (GB); Joseph Michael Birks, Lancashire (GB)

(21) Appl. No.: 14/357,284

(22) PCT Filed: Oct. 30, 2012
(86) PCT No.: PCT/GB2012/052696

§ 371 Date: May 9, 2014

(30) Foreign Application Priority Data
Nov. 9, 2011 (GB) 1119342.2

(51) Int. Cl. F16G 11/04

(52) U.S. Cl. CPC F16G 11/046
USPC 24/115 K

(57) ABSTRACT

The following invention relates to a locking clip (1), specifically a geometric friction device for securing cord-like materials (3), particularly a locking clip for securing a length of resilient rubber cord, yet more specifically for providing a means of attaching resilient rubber cords to furniture items to convert said furniture items into resistance training apparatus for the purpose rehabilitation or fitness training. The locking clip comprising a housing (2) which comprises a plurality of chambers, providing means for forming a fixing loop (4), and a locking chamber (12), wherein said at least one locking chamber is located at an acute angle (a) to at least one of the plurality of chambers.

The following invention relates to a locking clip, specifically a geometric friction device for securing cord-like materials, particularly a locking clip for securing a length of resilient rubber cord, yet more specifically for providing a means of attaching resilient rubber cords furniture items to convert said furniture items into resistance training apparatus for the purpose rehabilitation or fitness training.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

According to a first aspect of the invention there is provided a locking clip for retaining a cord comprising,

a housing comprising a first chamber with an entrance port and an exit port to accommodate a length of a cord,

a second chamber with an entrance port substantially parallel to the first chamber exit port, so as to provide a fixing loop of said cord, the fixing loop and housing allowing attachment to a fixing point.

the second chamber's exit is substantially orthogonal to its entrance port,

the housing further comprising at least one locking means, wherein the locking means comprises at least one locking chamber

which extends through the housing and is located at an acute angle (a) with respect to the plane of the second chamber exit port,

optionally a further chamber comprising an entrance and exit port arranged, such that they are in a substantially orthogonal arrangement, wherein the further chamber entrance port is located on the same face of the housing as the locking chamber exit port.

In a preferred arrangement the exit port of the first chamber is normal to the loading plane. The cord is able to be feed freely through each of the chambers.

The arrangement of the locking chamber at an acute angle to the second chamber's exit port creates significant mechanical resistance, which prevents the cord slipping through the chambers in the housing of the locking clip.

It has been shown that where the locking chamber is located substantially parallel to the second chamber exit port the device fails to provide locking engagement. The cord as it is passed from the locking chamber to the further or a fourth chamber, is preferably subjected to a further acute angle, such that it provide a further locking engagement.

The locking clip according to the invention does not require any moving or protruding parts to provide the locking arrangement of a length of cord to provide a fixing loop. The locking clip does not require any biasing means, clamp or mechanical faster which is brought into contact with the cord, in order to retain the cord in the housing. The locking clip as defined herein provides the locking engagement i.e. the ability to retain the cord, by the arrangement of the plurality of chambers and their spatial relationship to one another. The locking chamber is a geometric friction device, thus reducing the risk of failure of the locking device. Further the removal of moving or protruding members, such as for examples, grips, spikes, clamps or pinching devices, will mitigate against additional wear on the cord. The use of any form of grip devices to retain cords may cause early failure of the cord, at their point of contact.

The fixing point may be any anchorage point, to which the fixing loop of the cord is required to be reversibly connected. The fixing point may be an additional mount to a body or structure, or the fixing point may be existing or integral element of a body or structure, such as an accessible part of the structure or body around which a loop may be formed.

The cord may be manufactured from any commonly used material. The cord maybe selected from a high or low flexibility cord material, and maybe extensible or substantially inextensible. The cord's material may be selected from twisted strands or fibres, ropes, braided ropes, bands manufactured from either man-made or naturally sourced materials, or combination therefo, such as for example cellulose, elastomers or rubber, preferably the cord is a resilient rubber cord or band.

The cord maybe of any geometrical cross section, such examples are, but not limited to, round, square, and flat cross section materials, such as, for example bands.

The chamber is a through hole, which houses the cord. The chambers may have a diameter selected such that the selected cord can be fed through and subsequently removed. The arrangement of the chambers provides the locking mechanism, and as such the chambers may allow many different diameters of cord to be passed through, thus a locking clip according to the invention may be used with a variety of diameters of cord. The diameter of the chamber may be constant throughout the entire length of each chamber or the chamber diameters may be tapered along their length to further increase resistance and promote locking engagement. In a further embodiment respective chambers may have different diameters. The chamber may have any cross section, such as, for example circular, square etc, in order to accommodate the shape of the cord.

The entrance port is the opening into which the cord is fed in, and the exit port is the opening through which the cord exits.

The locking means is provided by a plurality of chambers, particularly at least one locking chamber, said chambers arranged at angles with a variety of orientations to provide a compact design. In a preferred arrangement the cord is located through the plurality of chambers which extend through the width of the housing, to reduce the amount of cord that is required to provide the locking engagement, via the locking means.

The housing may be an elongate housing defined by an elongate xy plane, such that the first chamber extends through the housing parallel with the elongate plane. This allows the cord to be fed through the housing and to create a loop. The loop can be located around a fixing point, and then the cord is fed into the second chamber to close the loop around the fixing point.

Preferably the second chamber has an entrance port which is on the same face of the housing as the exit port of the first chamber. This allows for a loop to be formed in the cord, and for the loop of cord and housing to provide a clamp to a fixing point. The co-location of exit and subsequent entrance ports allows for easy threading of bulky cords from one exit port to the subsequent entrance port.

The second chamber's exit may be orthogonal to its entrance port, this provides increased resistance for the locking engagement and the cord may be arranged substantially parallel to the first elongate xy plane of the housing.

The locking chamber entrance port is preferably on the same face of the housing as the second chamber exit port, to allow ready transfer of cord from the exit port to the entrance port. This transfer also ensures that a very discrete loop is formed, rather than lengths of cord being wrapped around the housing, which would be bulky and may provide a snagging hazard, particularly in a hospital environment.

The locking chamber lies at an acute angle (a) to the yz plane, the Angle (a) is in the range of 1° to 45°, preferably in the range of from 2 to 30°, more preferably in the range of from 10° to 30°, yet more preferably in the range of from 20° to 30°. A particularly preferred angle is 15°, as this provides an angle which provides locking engagement without causing excessive wear or damage to the cord. The acute angle (a) of the chamber provides the locking engagement of the cord.

This facilitates a more compact design of locking clip and is more economic on the cord since less is required for the locking engagement, in addition the exit port from a given chamber may be located on the same plane as the entrance port of the next sequenced chamber.

The housing may be manufactured from any suitable material that has structural integrity, such as, for example a metal, metal alloy, polymer or ceramic, preferably a polymer. The polymer may be formed by any conventional technique, such as, for example moulding or additive layer processes to form the product in a layer wise process.

The locking clip operates by having a load imposed on the cord, which runs through the first chamber of the locking clip, drawing out surplus cord to form the fixing loop. The second chamber secures one portion of the cord allowing the fixing loop to tighten around the angled entrance of the locking chamber, at which time the housing is held static against the anchor point, forming a secure and stable anchor point for the cord.

According to a further aspect of the invention there is provided a locking clip for retaining a cord comprising a housing which comprises a plurality of chambers, wherein at least two chambers provide a means for forming a fixing loop, and at least one chamber forms at least one locking chamber, wherein said at least one locking chamber is located at an acute angle (a) to at least one of the plurality of chambers.

The locking chamber lies at an acute angle(a) to the yz plane, the Angle (a) is in the range of 1° to 45°, preferably in the range of from 2 to 30°, more preferably in the range of from 10° to 30°, yet more preferably in the range of from 20° to 30°. A particularly preferred angle is 15°, as this provides an angle which provides locking engagement without causing a resilient rubber cord to tear or undergo excessive wear. The acute angle (a) of the chamber provides the locking engagement of the cord.

The locking clip according to the invention may be used as a simple clip, or according to a further aspect of the invention there is provided a body, structure or handle comprising at least one clip according to the invention. This may permit a handle to readily incorporate a clip. The housing may comprise threads or other fixings such that the housing can be mounted to a body or structure, by conventional mechanical fixings. The locking clip according to the invention may form an integral part of a body, structure or handle.

According to a further aspect of the invention there is provided a locking clip for retaining a cord comprises a plurality of chambers, a means for forming a fixing loop, at least one locking shoulder, wherein said at least one locking shoulder is located at an acute angle (a) to at least one of the plurality of chambers.

The locking engagement may be formed either my providing the chamber or the locking shoulder at an acute angle so as to provide sufficient resistance and cause locking engagement of the cord.

According to a further aspect of the invention there is provided a method of securing a resilient rubber cord to a fixing point, comprising the steps of threading the cord through the device according to the invention, comprising the steps of forming a loop, and then threading the cord through the locking means, and pulling the cord tight.

According to a yet further aspect of the invention there is provided a furniture mounted exercise machine, comprising at least one resistance cord, at least two locking clips according to the invention, a handle wherein the handle comprises a strain gauge, wherein the resistance cord is connected to the furniture and handle by the at least two locking clips.

An embodiment of the invention will now be described by way of example only and with reference to the accompanying drawings of which:

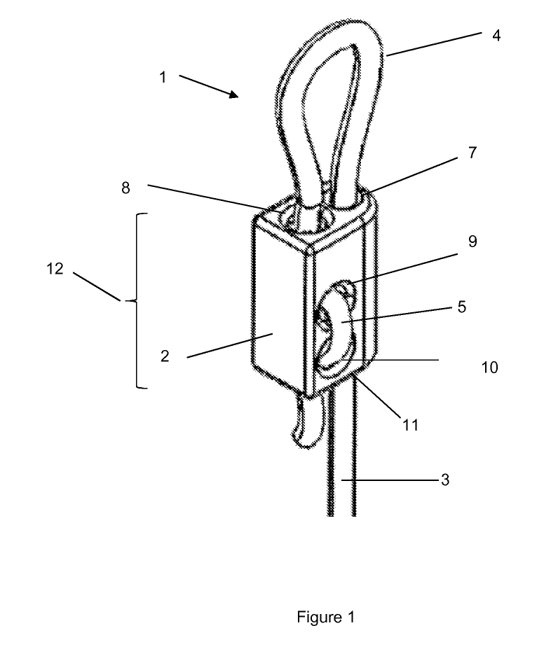

FIG. 1 shows a side projection of a locking clip and cord.

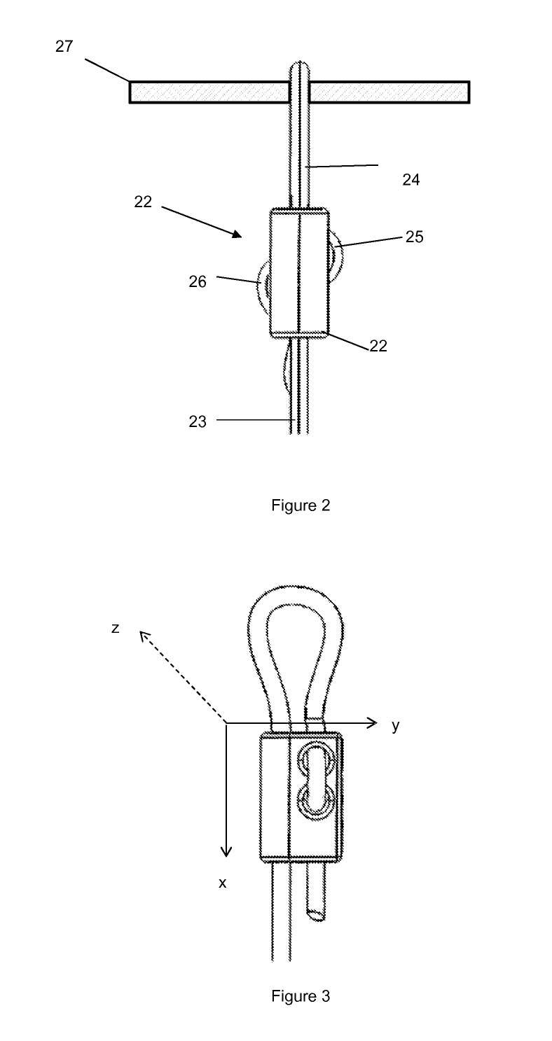

FIG. 2 shows a side view of a locking clip and cord.

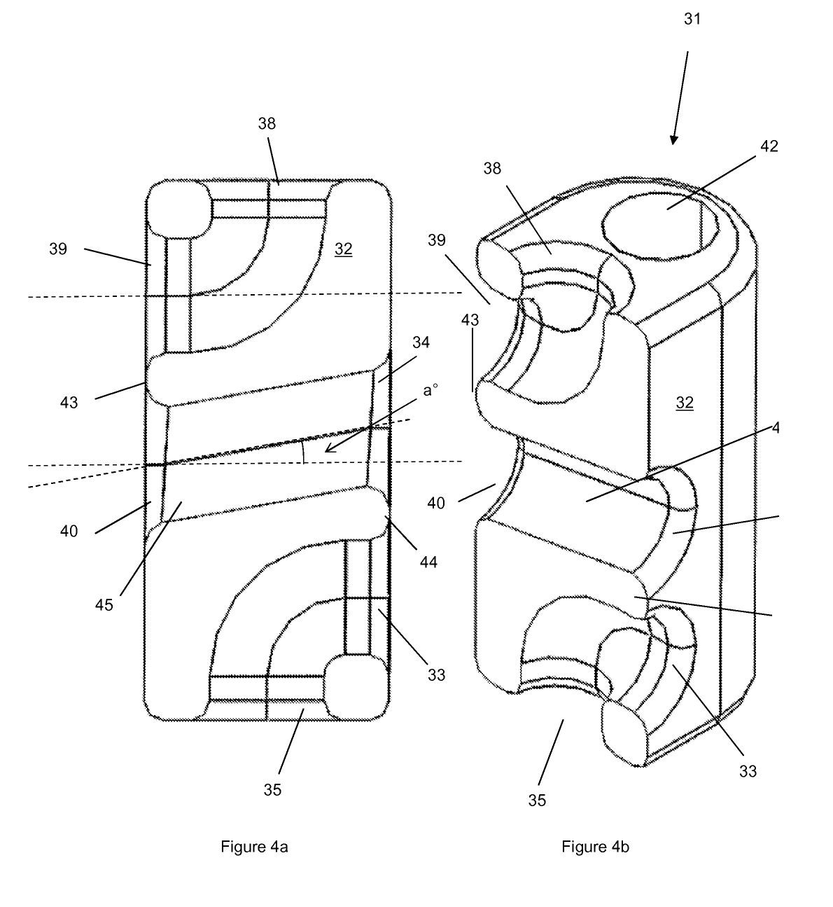

FIG. 3 shows a further side view to show relative positions of the features of the locking clip.

FIGS. 4a and 4b show a cross section and partial section, respectively of the locking means.

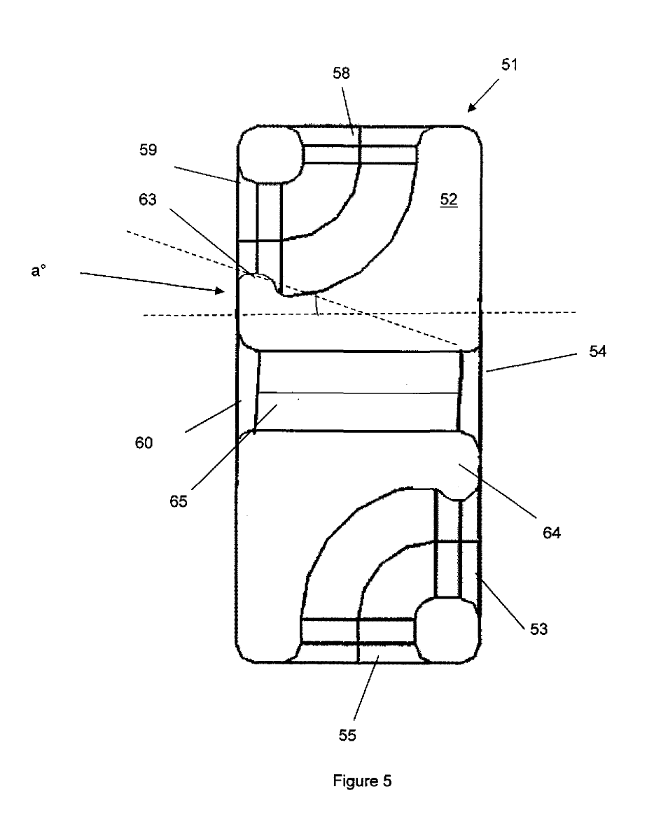

FIG. 5 shows a cross section of an alternative locking means.

Turning to FIG. 1, there is provided a locking clip 1, with a housing 2. A cord 3, is passed through the entrance port 11 of the first chamber (not shown), the cord emerges from the first chamber exit port 7. A fixing loop 4, is prepared and the cord is then passed into the locking mechanism 12, the sequence of chambers on the left hand side of the figure.

The cord is fed through a second chamber via entrance port 8, whose exit port 9 is orthogonal, a small loop 5 is created as the cord 3 is passed into the locking chamber (not shown) via the locking chamber entrance port 10. The cord then passes through a further chamber (not shown) such that the cord 3 neatly emerges parallel to the original cord entrance port 11.

FIG. 2 shows a side view of the locking clip 22, wherein the fixing loop 24 is located around a fixing point 27, which may be a rail on a hospital bed. The cord 23 passes from the second chamber to the locking chamber create loop 25 and form the locking chamber to a further chamber to create loop 26. The further chamber provides a further locking mechanism and further a means of bringing the end of the cord 3 out of the clip 22 at a position to create a neat and tidy arrangement.

FIG. 3 shows a top view of the locking clip, with the elongate axis running along the X-axis.

FIG. 4a and FIG. 4b show sections through a locking clip 31. The first chamber 42 may extend the entire length of the clip 31, so as to keep the cord and clip in a neat and tidy manner. The cord not shown for clarity, enters the second chamber entrance port 38, passing through a substantially 90° bend and emerging from the exit port 39. The cord is passed over the locking shoulder 43, the locking chamber 45 is set at an acute angle (a) from the exit port 39. The acute angle (a) and locking shoulder 43 provide resistance and prevent the cord from moving. The cord emerges from the locking chamber 45 and exits via exit port 34, the cord is passed over a further locking shoulder 44 and is fed into a further or in this case a fourth chamber via entrance port 33. The shoulder 44 and the entrance port of the further chamber 33, provide further locking engagement of the cord. The cord finally emerges via substantially 90° bend from the exit port 35, such that the end of the cord exits next to the original cord entrance port (not shown).

The chambers may be orientated such that the exit ports emerge out of the plane, this would provide locking engagement, provided that locking shoulder 43 and preferably locking shoulder 44 are present. However, re-arranging the exit ports would provide a more tortuous path an leave cord bulging from the clip body 32.

FIG. 5 shows a cross section through a locking clip 51. The cord not shown for clarity, the cord enters the second chamber entrance port 58, passing through a substantially 90° bend and emerging from the exit port 59. The cord is passed over the locking shoulder 63, the locking shoulder is set at an acute angle (a) from the exit port 59. The acute angle (a) locking shoulder 43 provides resistance and prevents the cord from moving. The cord emerges from the locking chamber 65 and exits via exit port 64, the cord is passed over a further locking shoulder 64 also arranged at an acute angle (a), and is fed into a further or in this case a fourth chamber via entrance port 53. The locking shoulder 64 and the entrance port of the further chamber 53, provide further locking engagement of the cord. The cord finally emerges via substantially 90° bend from the exit port 55, such that the end of the cord exits next to the original cord entrance port (not shown).

1. A locking clip for retaining a cord comprising:
a housing comprising a first chamber with an entrance port and an exit port to accommodate a length of a cord;
a second chamber with an entrance port substantially parallel to the first chamber exit port, so as to provide a fixing loop of said cord, the fixing loop and housing allowing attachment to a fixing point;
the second chamber's exit being substantially orthogonal to its entrance port; and
housing further comprising at least one locking means, wherein the locking means comprises at least one locking chamber which extends through the housing and is located at an acute angle (a) with respect to the plane of the second chamber exit port.

2. A clip according to claim 1, wherein the housing is an elongate housing defined by the elongate xy plane, such that the first chamber extends through the housing parallel with the elongate plane.

3. A clip according to claim 1, wherein the second chamber has an entrance port which is on the same face of the housing as the exit port of the first chamber.

4. A clip according to claim 1, wherein the second chamber exit is orthogonal to its entrance port, and the cord is substantially parallel to the first elongate xy plane of the housing.

5. A clip according to claim 1, wherein the locking chamber entrance port is on the same face of the housing as the second chamber exit port.

6. A clip according to claim 1, wherein the locking chamber lies at an acute angle (a) to the yz plane.

7. A clip according to claim 6 wherein the angle (a) is in the range of from 10° to 20°.

8. A clip according to claim 1, wherein the exit port from any chamber is located on the same plane as the entrance port of the next sequenced chamber.

9. A clip according to claim 1, wherein the housing is manufactured from a metal, metal alloy, plastic or ceramic.

10. A clip according to claim 1, wherein the cord is a resilient rubber cord.

11. (canceled)

12. A locking clip for retaining a cord, comprising:
a plurality of chambers;
a means for forming a fixing loop; and
at least one locking chamber, wherein said at least one locking chamber is located at an acute angle (a) to at least one of the plurality of chambers.

13. A locking clip according to claim 12, further comprising a housing which comprises the plurality of chambers, wherein at least two chambers provide the means for forming a fixing loop, and at least one chamber forms the at least one locking chamber.

14. (canceled)

15. A method of securing a resilient rubber cord to a fixing point, the method comprising:
providing a locking clip comprising a housing having a first chamber with an entrance port and an exit port to accommodate a length of a cord, and a second chamber with an entrance port substantially parallel to the first chamber exit port, so as to provide a fixing loop of said cord, the fixing loop and housing allowing attachment to a fixing point, the second chamber's exit being substantially orthogonal to its entrance port, and the housing further comprising at least one locking means, wherein the locking means comprises at least one locking chamber which extends through the housing and is located at an acute angle (a) with respect to the plane of the second chamber exit port;
threading the cord through the locking clip;
forming a loop; and
threading the cord through the locking means.

16-17. (canceled)

18. The locking clip of claim 1, further comprising a further chamber having an entrance and exit port arranged such that they are in a substantially orthogonal arrangement, wherein the further chamber entrance port is located on the same face of the housing as the locking chamber exit port.
